(19) United States
(12) Patent Application Publication
(10) Pub. No.: US 2021/0257896 A1
(43) Pub. Date: Aug. 19, 2021

(54) Movement and Vibration energy harvesting

(71) Applicants: Dan Haronian, Efrat (IL); Michael Haronian, Efrat (IL)

(72) Inventors: Dan Haronian, Efrat (IL); Michael Haronian, Efrat (IL)

(21) Appl. No.: 17/175,665

(22) Filed: Feb. 14, 2021

Related U.S. Application Data
(60) Provisional application No. 63/149,281, filed on Feb. 14, 2021.
(60) Provisional application No. 62/977,509, filed on Feb. 17, 2020.

(51) Int. Cl. H02K 35/02

(52) U.S. Cl. CPC H02K 35/02

(57) ABSTRACT

A device for harvesting electricity from vibrations of a body that includes a coil with a core that are designed to be fixed to the body, a spring with a suspending magnet attached to its first end in a way that the magnet is positioned close to the core and the second end of the spring is designed to be fixed to the body. The device also includes an electric device that includes a power management circuit that is connected to the coil and an electric energy storing device, and a gap controlling device that is capable to control the distance between the core and the suspending magnet. The vibrations cause the magnet to vibrate relative to the core and to induce electric current in the coil and the energy harvesting can be optimized by controlling the distance between the core and the magnet.

### BACKGROUND OF THE INVENTION

Ground moving vehicles such as automotive or bicycles are subject to unwanted vertical movements including vibration and shocks. These movements are typically damped using shock absorbers. The vertical movement may be converted into electricity in order to power electric devices connected or disconnected to the vehicle. In a similar way machine vibration may be harvested in order to supply power to electric device connected or disconnected to the machine.

Patent application WO 2010/094312 is related to a method for charging at least one motor vehicle battery by converting mechanical power of the vehicle suspension into electricity. This patent claims A method for charging at least one motor vehicle battery during the operation of the motor vehicle, in which the charging current for the motor vehicle battery is obtained at least partially by converting mechanical power on the vehicle suspension and the mechanical power is a spring power on at least one shock absorber of the motor vehicle wherein a control unit for controlling the charging current makes possible a regulation of the damping behavior at least of one shock absorber, and that the shock absorber comprises at least one linear motor, which is operated as a generator and as a servomotor.

Patent application U.S. Pat. No. 6,952,060 B2 is related to linear motion energy recovery and energy conversion generators. More particularly, this invention relates to efficient, variable frequency, electromagnetic generators for converting parasitic intermittent linear motion and vibration into useful electrical energy. Most particularly, this invention relates to regenerative electromagnetic shock absorbers which both dampen displacement motion and vibrations and convert these into useful electrical energy.

The paper by Mohamed A. A. et., al. titled “Vibration energy harvesting in automotive suspension system: A detailed review,” Applied Energy 229 (2018) 672-699, discusses energy harvesting based on vehicle suspensions. The paper it focuses on vehicle regenerative suspensions using four-phase linear generator.

The published patents and publication regenerate vibration to electricity using some type of magnets arrangement relative to coil or coils. None of the patent or publication uses a coil winded over a coil or a magnet arrangement that may be adjusted relative to the core as function of the vibration field.

The regenerated electric power may power batteries such as batteries of an electric vehicle or to power sensors used by the vehicle. In addition, bicycles use mechanical wires to control the brakes, the gear shifting and the saddle height. Installing wires through the bicycle body or along the body damages the bicycle body and is intensive labor. In addition, the shock absorbers are adjusted by a knobs located on the front and back shock absorbers. Adjusting the shock absorber knobs while riding requires moving the hand far from the handle and may be risky.

A new trend has recently emerged that uses wireless communication to control bicycle accessories. This is achieved by wireless communication between a controller fixed to the handlebar and a motors that are connected to accessories such as gear shifter, brakes, and the saddle height adjuster. These motors are powered by a rechargeable battery that requires recharging every several hours.

In addition, a bicycle shock absorber is typically made of a gas or spring in a sealed chamber. When the shock absorber is compressed the gas or spring is compressed to absorb the shock. The rebound of the shock observer is typically done through an oil system that is forced to flow through small holes that may be adjusted in order to control the rate of the rebound.

### SUMMARY OF THE INVENTION

This patent application is related to converting vertical movement of a vibrating body into electricity using magnets arrangement relative to coils winded on cores. The distance between the magnets and the core or coil may be adjusted according to the vibrations such that power conversion efficiency may be maximized.

### BRIEF DESCRIPTION OF THE DRAWINGS

FIG. 1a depicts an example of an energy harvesting device for harvesting vibration from vibration of a Body.

FIG. 1b depicts a description of ferromagnetic plates around the coil for magnetic flax confinement around the coil

FIG. 2 depicts power generated by an Electromagnetic Vibration Energy Harvester as function of the core to magnet distance.

FIG. 3a depicts a general description of an embodiment of an Electromagnetic Vibration Energy Harvester.

FIGS. 3b and 3c depict details of an embodiment of an Electromagnetic Vibration Energy Harvester.

FIG. 4 depicts one embodiment of the Electromagnetic Vibration Energy Harvester described in FIG. 3 as part of a shock absorber.

FIGS. 5a and 5b depict another embodiment of the Electromagnetic Vibration Energy Harvester described in FIG. 3 as part of a shock absorber.

FIGS. 6a and 6b depict general description of one embodiment of an adjustable Electromagnetic Vibration Energy Harvester.

FIG. 7 depicts general description of another embodiment of an adjustable Electromagnetic Vibration Energy Harvester.

FIG. 8a depicts general description of another embodiment of an adjustable Electromagnetic Vibration Energy Harvester.

FIG. 8b depicts the adjustable Electromagnetic Vibration Energy Harvester described in FIG. 8a integrated in a shock absorber.

FIG. 8c depicts the adjustable Electromagnetic Vibration Energy Harvester described in FIG. 8a integrated in two states.

FIG. 9a depicts a schematics description of an Electromagnetic Vibration Energy Harvester connected to power management circuit and electric energy storing device.

FIG. 9b depicts a schematics description of an Electromagnetic Vibration Energy Harvester described in FIG. 8 connected to power management circuit and electric energy storing device.

### DETAILED DESCRIPTION OF THE INVENTION

This patent application is of a device for converting mechanical energy generated from movements or vibrations of a Body into electric energy. The moving or vibrating Body may be for example any kind of machine or any kind of a vehicle including bicycle and scooter. The device comprises a core winded by a coil that is fixed to the body. A spring, fixed at its base to the body, suspends a magnet close to the core. As the body vibrates it forces the electromagnetic device to vibrate such that the vibrations of the magnet induce an electric current in the coil. This current may be connected to a power management circuit for rectifying and adjusting the electric properties of the harvested power and stored in a rechargeable battery or a supper capacitor. The power management and the stored energy may be used to power devices such as sensor, batteries, or accessories or external to the Body. The distance between the core and the magnet may be adjusted in order to maintain high efficiency of power conversion.

In another embodiment the device comprise at least one magnet that is fixed to a piston that is connected to a first part of the Body and a coil winded on a core are fixed to a second part of the Body such that movement of first part relative to the second part may induce current in the coil and such that the current is managed by the power management circuit and is stored in the electric energy storing device and such that the electric device may be used to power electrical devices. The distance between the core and the magnet may be adjusted in order to maintain high efficiency of power conversion. The generated current may induce a magnetic field in opposite polarity to the magnetic field of the magnet, that may damp the relative movement between the first part and the second part.

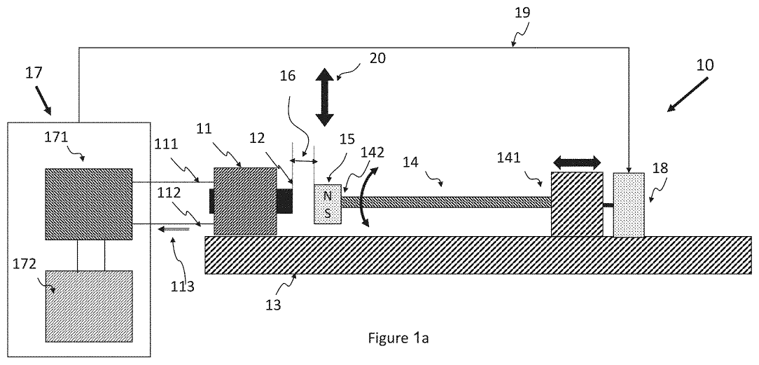

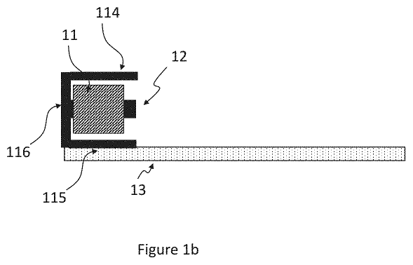

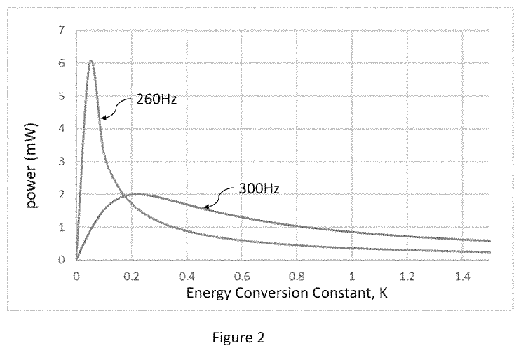

Reference is made to FIG. 1 describing one embodiment of this invention. FIG. 1a details an electromagnetic vibration energy harvesting device for converting vibration into electricity. The device comprises a coil (11) winded on a ferromagnetic core (12) that is designed to be attached to a Body (13). A spring (14) fixed at one side (141) to the Body is suspending a magnet (15) at some distance (16) away from the core. The device also includes an electric device (17) comprising power management circuit (171) that is connected to the wires of the coil (121, 122) and an electric energy storing device (172). When the Body vibrates (20) it forces the magnet to vibrate relative to the core such that an electric current is induced in the coil. This current is adjusted by the power management circuit (141) and is stored in the electric energy storing device (142) such that device (17) may be used to power electrical devices. Magnetic strength adjusting device (18) may be used to change the magnetic strength at the core by changing the distance (16) such that the energy harvesting of the device is optimized according to the road conditions. This will be demonstrated in FIG. 2. Device (18) may be fed by data (19) from electric device (17) in order to find the gap (16) for optimal energy harvesting.

Equation 1 describes the electromotive force measured in volts that is generated in a coil.

E=−N·dF/dt (1)

In this equation N is the number of turns of the coil and F is the magnetic flux. Moving a magnet relative to a coil generates dF/dt. Clearly the large dF/dt the larger E. Reversing the magnetic flux results in a very high change to the magnetic flux and thus the high electromotive force. This is achieved by using a core (12) as described in FIG. 1a, such that the up and down movement of the magnet relative to the core inverses the polarity resulting in high change in the magnetic flax. Upper (114), lower (115) and side (116) ferromagnetic plates, as descried in FIG. 1b, may be used in order to confine the magnetic field close to the coil (11).

Reference is made to FIG. 2 describing graphically the electric power harvested by an electromagnetic vibration energy harvesting device, described in FIG. 1, as a function of the gap between the core and the magnet. It is noted that the peak of power conversion is a function of the distance between the core and the magnet. Adjusting the distance between the core and the magnet depending on the vibration condition and vibration amplitude allow optimal vibration energy to electric energy conversion.

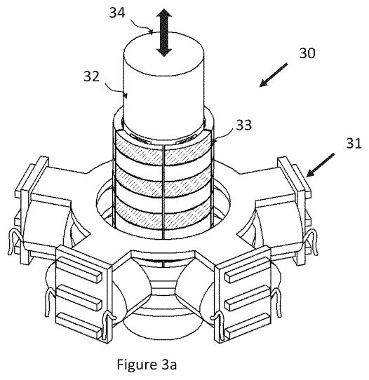

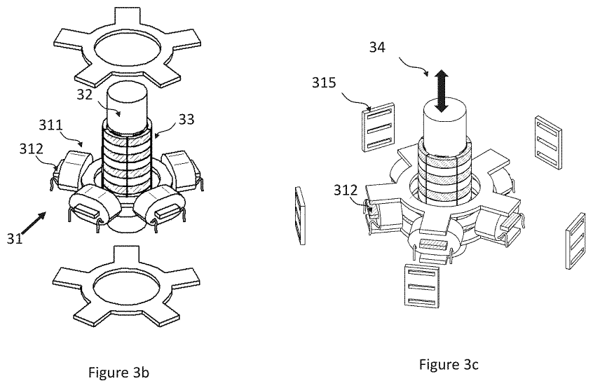

Reference is made to FIG. 3 describing an electromagnetic vibration energy harvesting and a damping device (30). FIG. 3a is a general view of the module and FIGS. 3b and 3c, shows details of the module. The device comprises plurality of electromagnetic device (31) made of a conductive coil (311) wrapped on a core (312) and arranged around a shaft (32). Upper (313), lower (314) and side (315) ferromagnetic plates may be used in order to form a magnetic circuit to channel the magnetic flax across the coil (311). At least one magnet (33) with vertical magnetic polarity is fixed on a shaft peripheral (32) such that up and down movement (34) of the shaft relative to the electromagnetic device (31) may generate current in the coil. The current in turn may generate a magnetic field in the opposite direction to the magnetic field generated by the magnet and therefore damp the movement of the electromagnetic device (31) relative to the shaft (32).

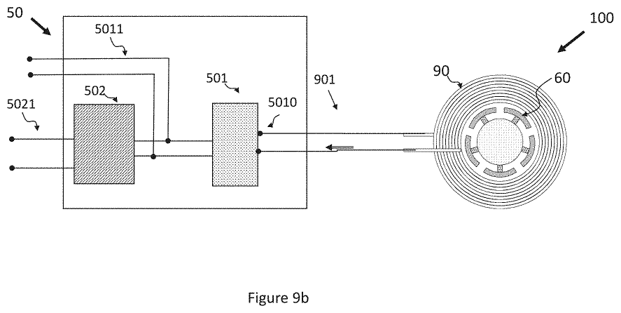

It is noted that current may be generated in the coils only when the coil's ends are part to a closed electric circuit. It is also noted that, assuming zero coil resistance, coil's ends connected to each other will not develop voltage and therefore no electric power will be harvested. Details on electric circuit will be described in FIG. 9.

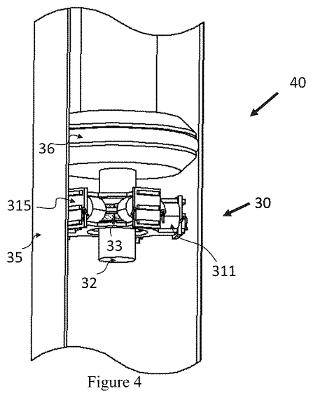

Reference is made to FIG. 4 describing the electromagnetic vibration energy harvesting and a damping device (30) as part of a shock absorber (40) comprising a cylinder (35) and a piston (36). Electromagnetic device (31) is fixed to the cylinder, for example, through the back ferromagnetic plates (315). The shaft (32) with at least one magnet (33) is connected to the piston, such that movements of the cylinder relative to the piston may generate current in the coils (311). The current in turn, may generate a magnetic field in opposite direction to the magnetic field generated by the magnet and therefore damp the movement of the cylinder relative to the piston. It is noted that the shock absorber may include additional parts that are typically used in shock absorber such as spring, compressed air, and holes in the piston.

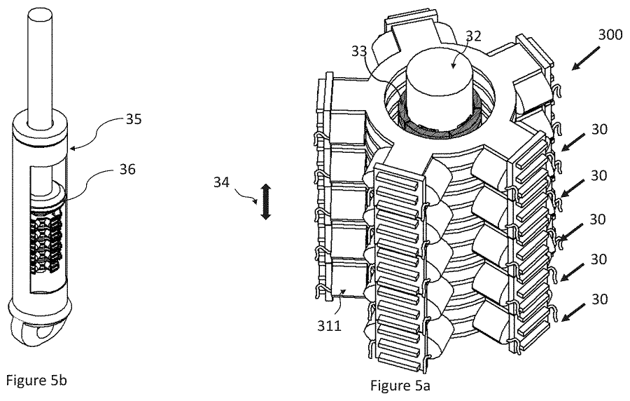

Reference is made to FIG. 5. FIG. 5a describes device (300) comprised of plurality of electromagnetic vibration energy harvesting and a damping device (30) combined together and FIG. 5b shows device (300) as part of a shock absorber. The cores comprising device (30) in device (300) are fixed to the cylinder (35). At least one magnet (33) is fixed to a shaft (32) that is connected to the piston (35), such that movements of the cylinder relative to the piston may generate currents in the coils (311). The currents in turn may generate a magnetic field in the opposite direction to the magnetic field generated by the magnet, that may damp the movement of the cylinder relative to the piston. It is noted that the shock absorber may include additional parts that are typically used in shock absorber such as spring, compressed air, and holes in the piston.

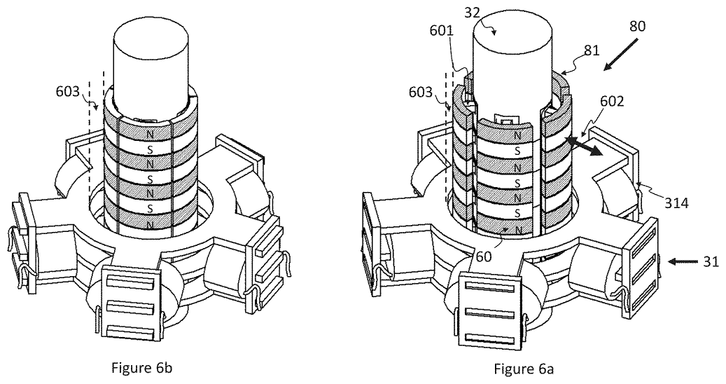

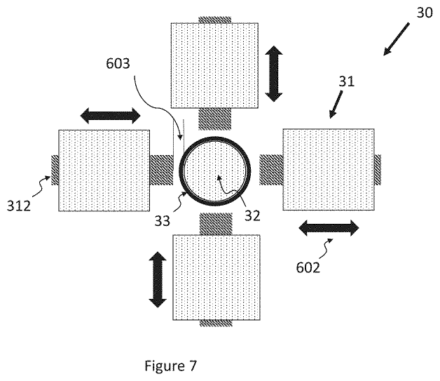

In the kinetic energy harvester and a damping device (30) described in FIGS. 4 and 5, the distance between the magnet and the core is fixed. As discussed above, adjusting the distance between the core and the magnet offers tuning the harvester to optimal power harvesting and in turn changes the damping of the movement between the cylinder and the piston. One way of core to magnet adjustment is described in FIGS. 6a and 6b. Here the electromagnetic vibration energy harvesting and a damping device (80) such that at least one magnet (81) is connected to the shaft through elements (601) that may move radially (602) and change the distance (603) between the magnets and the core (314). For simplicity electromagnetic module (31) is shown without the top, bottom and side ferromagnetic plates as detailed in FIG. 3. The movement of elements (601) may be done using a mechanical arrangement that may be imbedded inside the shaft. FIG. 6b describes device (80) such that the magnet is far from the core. Another way to adjust the core to magnet distance (603) is by moving the core and coil unit as described in FIG. 7.

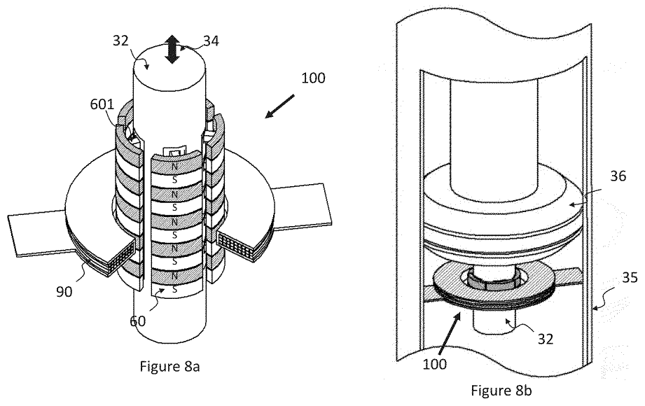

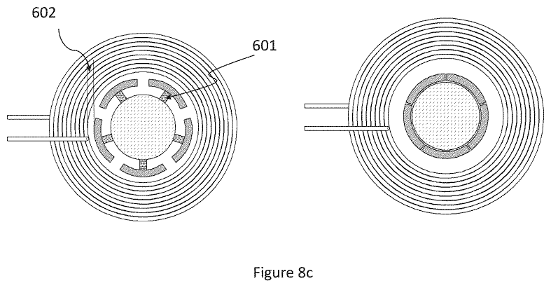

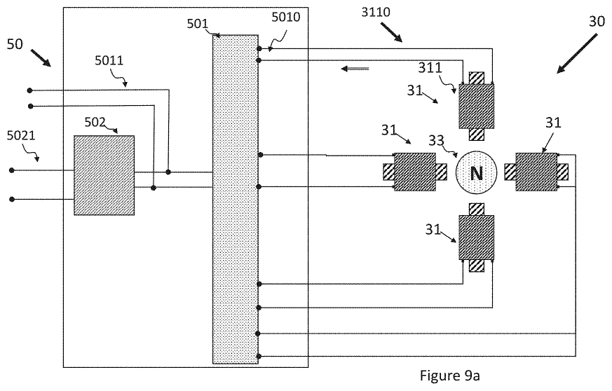

Reference is made to FIG. 8a through 8c describing adjustable electromagnetic vibration energy harvesting and a damping device (100). Here a coil (90) is wrapped around shaft (32) at some distance and is fixed to cylinder (34). At least one magnet (60) is connected to the shaft through elements (601) that may move radially and change the distance between the magnets and the coil. The movement of elements (601) may be done using a mechanical arrangement that may be imbedded inside the shaft. FIG. 8b demonstrate device (100) as part of a shock absorber such that the shaft is connected to a piston and the coil is connected to the cylinder. FIG. 8c demonstrate device (100) in two positions of the magnets relative to the coil.

FIG. 9a describes an electric schematics of connection of the coils (311) in the kinetic energy harvester and a damping device (30) that are described in FIGS. 4 through 7. The coils are connected to an electric module (50) that comprises a power management circuit (501) and an electric energy storing device (502). The power management device (502) rectifies and combines the current from different coils according to a preferred electric configuration.

It is noted that energy harvesting as referred to in this patent application can take place only when current flow in the coil AND voltage is developed between the wires of the coil. Therefore, Energy is harvested and the movement between a cylinder and a piston is damped depending on the electric load connected between the two ends of each coil. The power management (501) may include electric load that controls the strength of the current and by that controls harvested energy and the damping of the relative movement between the cylinder and piston described in this patent application.

Through the output terminals (5011) the harvested electric power may be used to either power devices or to charge the energy storing device (502) which in turn may be used to power devices through its terminal (5021).

In a similar way FIG. 9b describes an electric schematics for the adjustable electromagnetic vibration energy harvesting and a damping device (100) described in FIG. 8.

It is understood that energy harvesting and damping devices that are described in this patent application may, for example, be imbedded inside the chassis of a Body such as vehicle or bicycle or as part of a vehicle suspension system. The harvested power may be used to power electric devices imbedded in the Body or power devices that are external to the Body.

What is claimed is:

1. A device for harvesting electric energy from vibrations of a body comprising:
a coil with two ends winded on a core that is designed to be fixed to the body,
a spring with a first end to which a suspending magnet is attached, wherein the suspending magnet is positioned close to the core, and wherein a second end of the spring is designed to be fixed to the body,
an electric device that includes a power management circuit that is connected to the two ends of the coil and an electric energy storing device that is connected to the power management circuit,
a gap controlling device that is capable to control a distance between the core and the suspending magnet,
such that the vibrations can cause the magnet to vibrate relative to the core and to induce electric current in the coil and such that the harvesting energy from vibration can be optimized by controlling the distance between the core and the magnet and such that the electric current can be managed by the power management circuit and can be stored in the electric energy storing device such that the electric device can be used to power electrical devices.

2. A kinetic energy harvester and a damping device comprising:
a plurality of electromagnetic devices each comprising coil that is winded on a core, wherein said devices are arranged around a shaft,
at least one magnet with given magnetic polarity fixed to said shaft,
Such that vertical movement of the shaft relative to the core of the electromagnetic device can generate current in said coil and such that said current generate a magnetic field with opposite polarity to the polarity of the magnet that can damps the movement between the shaft and electromagnetic device.

3. The kinetic energy harvester and a damping device according to claim 2 that further includes plurality of device stacked one on top of the other.

4. The kinetic energy harvester and a damping device according to claim 2 such that said at least one magnet is made up of several smaller magnets and such that each smaller magnet is connected to the shaft through element that is designed to move radially and to change the distance between the magnets and the core.

5. The kinetic energy harvester and a damping device according to claim 2 such that each of said electromagnetic device is designed to move radially and to change the distance between the magnets and the core.

6. A kinetic energy harvester and a damping device comprising:
a coil that is winded around a shaft and fixed to a cylinder,
plurality of magnets fixed along and around said shaft and with given magnetic polarity such that each of said magnet is fixed to the shaft through element that is designed to move in a direction of the coil such that a distance between the magnets and the coil can be adjusted,
Such that a vertical movement of the shaft relative to the cylinder can generate current in said coil and such that said current generate a magnetic field with opposite polarity to the polarity of the magnets that can damps the movement between the shaft and electromagnetic device.

7. The kinetic energy harvester and a damping device according to claim 2 further includes an electric device comprising a power management circuit with input terminals and output terminals and an electric energy storing device, with input terminals and output terminals such that coil terminals of said electromagnetic device are connected to the input terminals of the power management where the current in the coils can be combined according to preferred electric configuration and adjusted to specific parameters, and such that said power management circuit can include electric load that can control the strength of the current and by that can control harvested energy and damping of relative movement between said shaft and said electromagnetic device and such that the output terminals of the power management can be used to power electric devices or to charge the energy storing device and such that the energy storing device can be used to power devices through the output terminal.

8. The kinetic energy harvester and a damping device according to claim 6 further including an electric device comprising a power management circuit and an electric energy storing device, such that coil terminals are connected to the power management) with input terminals and output terminals where the current in the coil can be adjusted to specific parameters and such that said power management can include electric load that can control a strength of the current and by that to control harvested energy and damping of relative movement between said shaft and said cylinder and such that the output terminals can be used to power electric devices or to charge the energy storing device and such that the energy storing device can be used to power devices through the output terminals.
